(19) United States
(12) Patent Application Publication
(10) Pub. No.: US 2012/0031240 A1
(43) Pub. Date: Feb. 9, 2012

(54) Ratchet Wrench

(75) Inventor: CHIHCHING HSIEH, Taichung City (TW)

(73) Assignee: KABO TOOL COMPANY, Taichung City (TW)

(21) Appl. No.: 13/116,009

(22) Filed: May 26, 2011

(30) Foreign Application Priority Data
Aug. 3, 2010 (TW) 099125765

(51) Int. Cl. B25B 13/46

(52) U.S. Cl. 81/63.2

(57) ABSTRACT

A ratchet wrench including a holding portion, a neck portion, a driving block, a controlling rod, a shifting lever, and a gear wheel is disclosed. The neck portion which is located at the top end of the holding portion has a cavity. The cavity has a first recess and an opening. The first recess is used for receiving a compressible elastic member and a ball. The opening is used for receiving and tightly fitting with a bendable elastic member. The driving block has a second recess to hold the bottom of the bendable elastic member, and the driving block has two adjacent arc grooves at its bottom. The controlling rod to links the driving block to shift the driving block in the cavity to allow the ball to be pressed into one of the arc grooves. The controlling rod can be applied to shift, rotate or both shift and rotate the driving block in the cavity.

### RELATED APPLICATIONS

This application claims priority to Taiwan Patent Application Serial Number 99125765, filed on Aug. 3, 2010. The entire disclosure of the application is hereby incorporated by reference herein.

### BACKGROUND

1. Technical Field

The present disclosure relates to wrench. More particularly, the present disclosure relates to a ratchet wrench.

2. Description of Related Art

A ratchet wrench is a matured and widely used tool. In consideration of the structure, various ratchet structures and gear wheels have been provided. However, people skilled in the art still dedicate in developing new ratchet structures.

### SUMMARY

Hence, an aspect of the disclosure is to provide a ratchet wrench that has a delicate ratchet structure for setting the operating direction of the gear wheel.

According to one embodiment of the disclosure, a ratchet wrench including a holding portion, a neck portion, a driving block, a controlling rod, a shifting lever, and a gear wheel is disclosed. The holding portion has a top end and a bottom end. The neck portion has a cavity, and the neck portion is located at the top end of the holding portion. The cavity has a first recess located at its bottom and an opening located at its top. The first recess is used for receiving a compressible elastic member and a ball in sequence, and the opening is used for receiving and tightly fitting with a bendable elastic member, such as a spring. The driving block is installed inside the cavity and has a second recess at its top to hold the bottom of the bendable elastic member, and also has two adjacent arc grooves at its bottom. The controlling rod is partially extended to the surface of the neck portion, and the controlling rod links the driving block to shift the driving block in the cavity and thus to allow the ball to be to pressed into one of the arc grooves by the compressible elastic member, thereby fixing the driving block at a predetermined angle and bending the bendable elastic member toward one side of the holding portion. Additionally, the shifting lever is located above the cavity. The shifting lever has a cave at its bottom to hold the top of the bendable elastic member, and thus the shifting lever is pressed by the bendable elastic member to rotate itself. The shifting lever has an arc shaped concave surface and a first teeth structure, wherein the arc shaped concave surface is located at the top of the shifting lever, and the first teeth structure is disposed at the arc shaped concave surface. The gear wheel is located above the shifting lever. The gear wheel has an accommodation space to install a ratchet, and the ratchet has a second teeth structure disposed at its outer surface corresponding to the first teeth structure of the shifting lever.

Accordingly, when being bent, the bendable elastic member resists the cave of the shifting lever to shift the shifting lever, and thus the first teeth structure engages one side of the second teeth structure to control the operating direction of the gear wheel. It is worthy to be noted that the controlling rod can be applied to shift, rotate or both shift and rotate the driving block in the cavity.

According to another embodiment of the disclosure, a ratchet wrench having similar structure with that described above is disclosed, except that the first recess of the cavity and the nearby arc grooves of the driving block described above are exchanged respectively. Meanwhile, the controlling rod is applied to rotate the driving block inside the cavity. On the other hand, the compressible elastic member and the bendable elastic are both can be formed by respective springs.

Therefore, the ratchet wrenches of the embodiments achieve the function that slightly moving the controlling rod to change the operating direction of the gear wheel.

### BRIEF DESCRIPTION OF THE DRAWINGS

FIG. 1 is a schematic view of the ratchet wrench according to one embodiment of the disclosure;

FIG. 2 is a schematic view depicting the operating direction controlling mechanism in FIG. 1;

FIG. 3 is an exploded view of the operating direction controlling mechanism in FIG. 2;

FIG. 4 is a schematic view of the ratchet wrench according to another embodiment of the disclosure; and

FIG. 5 is a schematic view of the ratchet wrench according to still another embodiment of the disclosure.

### DETAILED DESCRIPTION

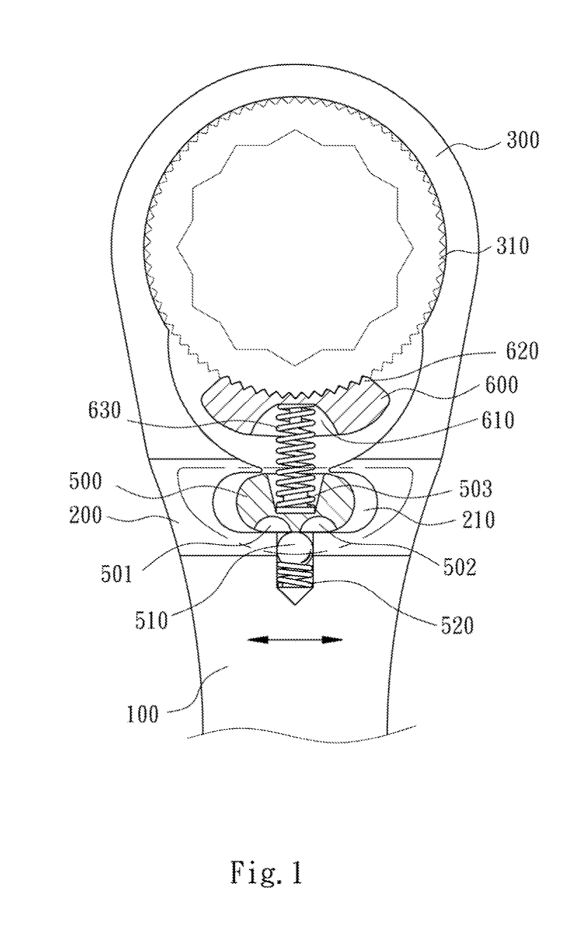

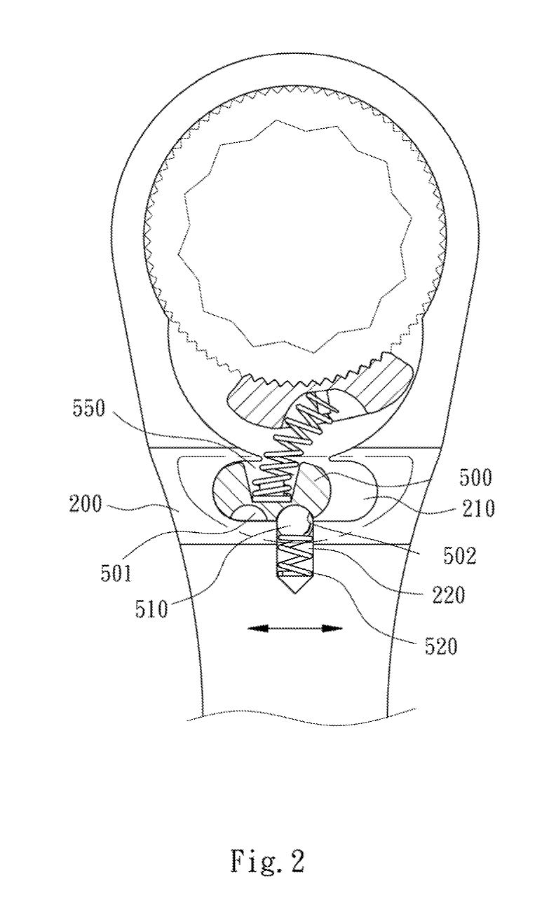

Referring to FIG. 1 and FIG. 2, FIG. 1 is a schematic view of the ratchet wrench according to one embodiment of the disclosure, and FIG. 2 is a schematic view depicting the operating direction controlling mechanism in FIG. 1. In FIG. 1, the ratchet wrench includes a holding portion 100, a neck portion 200, a driving block 500, a controlling rod (not shown), a shifting lever 600, and a gear wheel 300. The holding portion 100 has a top end and a bottom end. The neck portion 200 has a cavity 210, and the neck portion 200 is located at the top end of the holding portion 100. The cavity 210 has a first recess 220 (see FIG. 2) located at its bottom and an opening located at its top. The first recess 220 is applied to be filled with a compressible elastic member 520 and a ball 510 in sequence, and the opening is applied to be filled and tightly fit with a bendable elastic member 630. The driving block 500 is located inside the cavity 210. The driving block 500 has a second recess 550 at its top to hold the bottom of the bendable elastic member 630, and the driving block 500 also has two adjacent arc grooves at its bottom, i.e. the left arc groove 501 and the right arc groove 502. It is worthy to be noted that the shape of the second recess 550 must be designed to allow the bendable elastic member 630 to be bent inside the second recess 550.

The controlling rod links the driving block 500, and the controlling rod is extended to the surface of the neck portion 200. The controlling rod is applied to level shift the driving block 500 inside the cavity 210, and thus to allow the ball 510 to be pressed into one of the arc grooves by the compressible elastic member 520. Therefore, the driving block 500 is fixed at a predetermined angle by the ball 510 and thus the bendable elastic member 630 is bent toward either side of the holding portion 100. The shifting lever 600 is located above the cavity 210. The shifting lever 600 has a cave 610 at its bottom to hold the top of the bendable elastic member 630. The top structure of the shifting lever 600 is an arc shaped concave surface, and a first teeth structure 620 is disposed at the arc shaped concave surface. The gear wheel 300 is located above the neck portion 200, and the gear wheel 300 has a space to install a ratchet, and the ratchet has a second teeth structure 310 disposed at its surface to correspond the first teeth structure 620 of the shifting lever 600. Similarly, the shape of the cave 610 must be designed to let the bendable elastic member 630 able to be bent inside the cave 610.

In FIG. 2, when a user turns the controlling rod to level shift the driving block 500 to left, the ball 510 is pressed and stuck into the right arc groove 502. Meanwhile, the driving block 500 is fixed at a predetermined position, and thus the bendable elastic member 630 is bent toward the right side of the holding is portion 100. Therefore, the cave 610 is pressed to drive the shifting lever 600, and thus the first teeth structure 620 engages the second teeth structure 310 at the right side. As described above, the operating direction of the gear wheel 300 is set thereby, and thus the ratchet of the wrench can only be turned clockwise. On the contrary, if the user turns the controlling rod to level shift the driving block 500 to the right, the ball 510 is pressed and stuck into the left arc groove 501. Meanwhile, the bendable elastic member 630 is bent toward the left side of the holding portion 100. Therefore, the first teeth structure 620 engages the second teeth structure 310 at the left side, and thus the wrench can only be turned counter-clockwise.

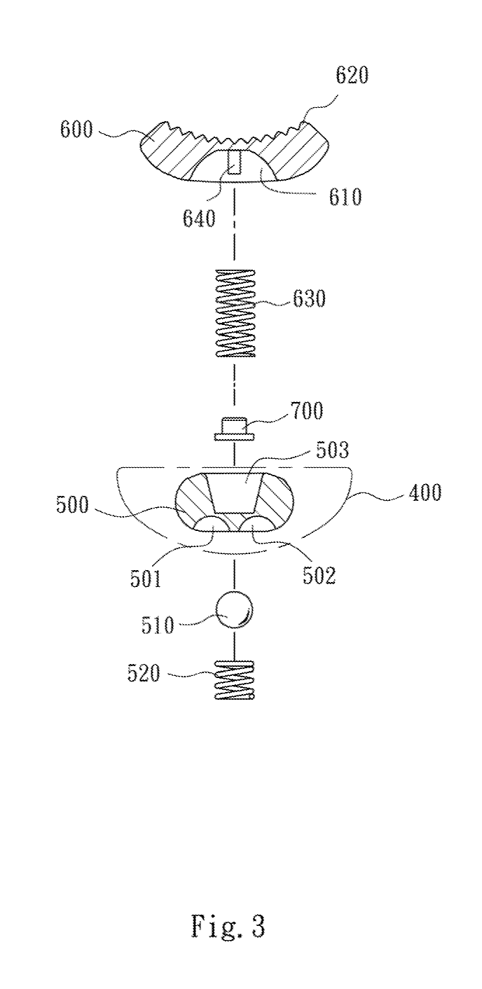

Referring to FIG. 3, FIG. 3 is an exploded view of the operating direction controlling mechanism in FIG. 2. In FIG. 3, the bendable elastic member 630 and the compressible elastic member 520 are both formed by respective springs. On the other hand, an axis block 640 and a filled block 700 are further provided to enhance the structure of the ratchet wrench. When the bendable elastic member 630 is a spring, the axis block 640 can be embedded into the top hollow space of the spring, and the filled block 700 can be embedded into the bottom hollow space of the spring. The axis block 640 with a diameter smaller than that of the spring prevents the spring from escaping from the cave 610 when the shifting lever 600 is rotated greatly. The filled block 700 can be applied to adjust the bending grade of the spring. The reason why the diameters of the axis block 640 and the filled block 700 are different from each other is that, the axis block 640 can be used to bear the force caused by the relative displacement between the spring and the shifting lever 600, and thus performs as a buffer. The filled block 700 is applied to fix the bottom of the spring. Therefore, the shape of the filled block 700 can be designed as a stick or a stick with a base. In detail, when the filled block 700 is a stick, the stick links the driving block 500. On the other hand, when the filled block 700 is a stick with a base, the base is pressed by the spring to contact the driving block 500 firmly. In consideration of the arc grooves, the left arc groove 501 and the right arc groove 502 are adjacent to each other, and thus the operating direction of the ratchet can be controlled by turning the controlling rod slightly.

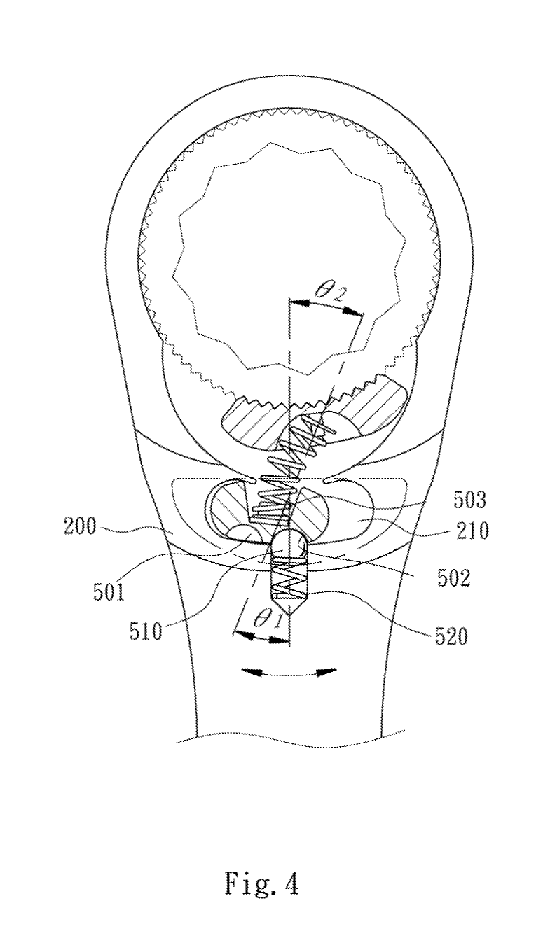

Referring to FIG. 4, FIG. 4 is a schematic view of the ratchet wrench according to another embodiment of the disclosure. In FIG. 4, the cavity 210 is designed to be a chamber with hollow arc space in shape. The driving block 500 is controlled by the controlling rod, and rotated inside the cavity 210. Therefore, as shown in FIG. 4, as long as the driving block 500 is rotated by the controlling rod with a small angle θ₁, the shifting lever 600 can be rotated with a large angle θ₂.

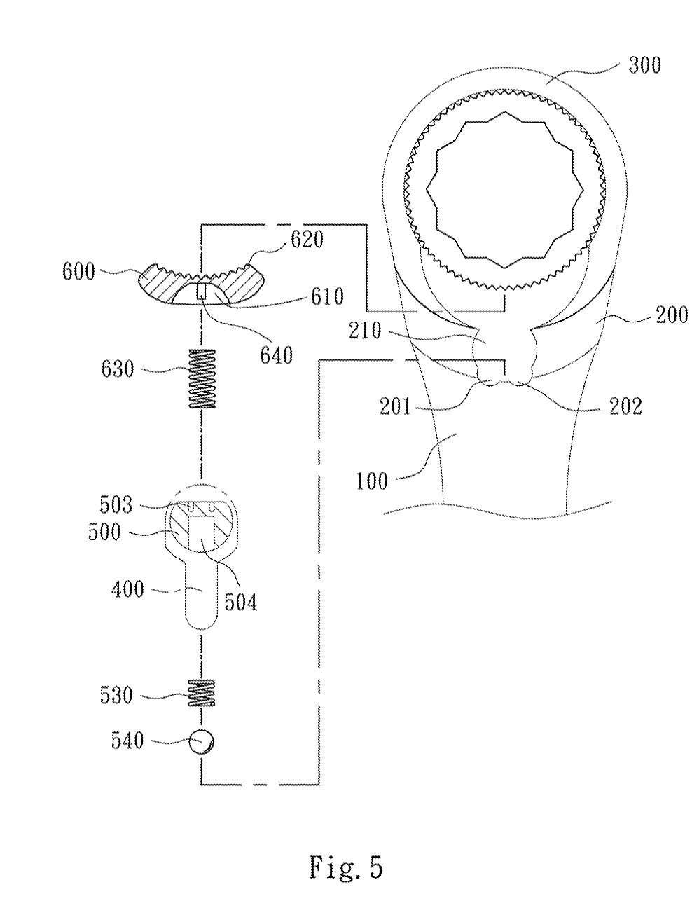

Finally, referring to FIG. 5, FIG. 5 is a schematic view of the ratchet wrench according to still another embodiment of the disclosure. In FIG. 5, the ratchet wrench includes a holding portion 100, a neck portion 200, a driving block 500, a controlling rod 400, a shifting lever 600, and a gear wheel 300. The holding portion 100 has a top end and a bottom end. The neck portion 200 has a cavity 210, and the neck portion 200 is located at the top end of the holding portion 100. It is worthy to be noted that the cavity 210 has an opening located at its top and two adjacent arc grooves located at its bottom, i.e. the left arc groove 201 and the right arc groove 202. The opening is applied to be filled and tightly fit with a bendable elastic member 630, such as a flexible stick or a spring. The driving is block 500 is located inside the cavity 210. The driving block 500 has a first recess 503 at its top to hold the bottom of the bendable elastic member 630, and the driving block 500 also has a second recess 504 at its bottom to hold the spring 530 and a ball 540 in sequence. The controlling rod 400 links the driving block 500, and is partially extended to the surface of the neck portion 200. The controlling rod 400 rotates the driving block 500 inside the cavity 210, and thus the ball 540 is pressed by the spring 530 and engaged into one of the arc grooves. Therefore, the driving block 500 is fixed at a shift position, and the bendable elastic member 630 is bent to the corresponding side.

The shifting lever 600 is located above the cavity 210. The shifting lever 600 has a cave 610 at its bottom to hold the top of the bendable elastic member 630. The top structure of the shifting lever 600 is an arc shaped concave surface, and a first teeth structure 620 is disposed at the arc shaped concave surface. The gear wheel 300 is located above the neck portion 200, and the gear wheel 300 has a space to install a ratchet, and the ratchet has a second teeth structure disposed at its surface to correspond the first teeth structure 620 of the shifting lever 600. Similarly, the shape of the cave 610 must be designed to allow the bendable elastic member 630 to be bent inside itself. Therefore, the first teeth structure 620 engages the second teeth structure of the gear wheel 300 at its either side when the shifting lever 600 is pressed by the bendable elastic member 630. As a result, the operating direction of the ratchet wrench can be controlled by slightly turning the controlling rod 400.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A ratchet wrench, comprising:
a holding portion having a top end and a bottom end;
a neck portion which has a cavity and is located at the top end of the holding portion, the cavity having a first recess located at its bottom and an opening located at its top, the first recess being filled by a compressible elastic member and a ball in sequence, the opening being inserted and tightly fit with a bendable elastic member;
a driving block installed inside the cavity, the driving block having a second recess at its top for holding a bottom of the bendable elastic member, the driving block having two nearby arc grooves at its bottom;
a controlling rod which extends to a surface of the neck portion and links the driving block to shift the driving block in the cavity, thus allowing the ball to be pressed into one of the arc grooves by the compressible elastic member, whereby, the driving block is fixed at a predetermined angle by the ball and thus the bendable elastic member is bent toward one side of the holding portion;
a shifting lever located above the cavity, the shifting lever having a cave to engage with a top of the bendable elastic member and being pressed by the bendable elastic member to rotate itself, the shifting lever having an arc shaped concave surface at its top and a first teeth structure disposed at the arc shaped concave surface; and
a gear wheel located above the shifting lever, the gear wheel having a space to install a ratchet, the ratchet having a second teeth structure disposed at its surface to correspond the first teeth structure;
wherein, the shifting lever is rotated and fixed when the bendable elastic member is bent, and thus the first teeth structure meshes one side of the second teeth structure to control an operating direction of the gear wheel.

2. The ratchet wrench of claim 1, wherein the controlling rod is applied to level shift the driving block in the cavity.

3. The ratchet wrench of claim 1, wherein the controlling rod is applied to rotate shift the driving block in the cavity.

4. The ratchet wrench of claim 1, wherein the compressible elastic member is a spring.

5. The ratchet wrench of claim 1, wherein the bendable elastic member is a spring.

6. The ratchet wrench of claim 5, further comprising an axis block inserted into a top hollow space of the spring.

7. The ratchet wrench of claim 5, further comprising a filled block inserted into a bottom hollow space of the spring.

8. A ratchet wrench, comprising:
a holding portion having a top end and a bottom end;
a neck portion which has a cavity and is located at the top end of the holding portion, the cavity having two nearby arc grooves at its bottom and an opening at its top, the opening being inserted and tightly fit with a bendable elastic member;
a driving block installed inside the cavity, the driving block having a first recess at its top for holding a bottom of the bendable elastic member, the driving block having a second recess located at its bottom, the second recess being filled by a compressible elastic member and a ball in sequence;
a controlling rod which extends to a surface of the neck portion and links the driving block to rotate the driving block in the cavity, thus allowing the ball to be pressed into one of the arc grooves by the compressible elastic member, whereby, the driving block is fixed at a predetermined angle by the ball and thus the bendable elastic member is bent toward one side of the holding portion;
a shifting lever located above the cavity, the shifting lever having a cave is to engage with a top of the bendable elastic member and being pressed by the bendable elastic member to rotate itself, the shifting lever having an arc shaped concave surface at its top and a first teeth structure disposed at the arc shaped concave surface; and
a gear wheel located above the shifting lever, the gear wheel having a space to install a ratchet, the ratchet having a second teeth structure disposed at its surface to correspond the first teeth structure;
wherein, the shifting lever is rotated and fixed when the bendable elastic member is bent, and thus the first teeth structure meshes one side of the second teeth structure to control an operating direction of the gear wheel.

9. The ratchet wrench of claim 8, wherein the compressible elastic member is a spring.

10. The ratchet wrench of claim 8, wherein the bendable elastic member is a spring.

11. The ratchet wrench of claim 10, further comprising an axis block inserted into a top hollow space of the spring.

12. The ratchet wrench of claim 10, further comprising a filled block inserted into a bottom hollow space of the spring.
